(19) United States
(12) Patent Application Publication
(10) Pub. No.: US 2022/0055027 A1
(43) Pub. Date: Feb. 24, 2022

(54) METHOD FOR ADJUSTING A CELL CONCENTRATION AND/OR A PARTICLE CONCENTRATION IN A DISPENSING SYSTEM

(71) Applicant: cytena GmbH, Freiburg (DE)

(72) Inventors: Jonas SCHÖNDUBE, Freiburg (DE); Lena LAUTSCHAM, Freiburg (DE); Clara SIBER, Freiburg (DE)

(21) Appl. No.: 17/417,444

(22) PCT Filed: Dec. 12, 2019
(86) PCT No.: PCT/EP2019/084880

§ 371 Date: Jun. 23, 2021

(30) Foreign Application Priority Data
Dec. 27, 2018 (LU) 101086

(51) Int. Cl. B01L 3/02; B01L 3/00; G05D 11/13; G01N 15/14

(52) U.S. Cl. CPC B01L 3/0268; B01L 3/502761; G05D 11/13; G01N 2015/142; B01L 2200/143; B01L 2400/0436; G01N 15/1404

(57) ABSTRACT

The invention relates to a method for setting a cell concentration and/or a particle concentration in a dispensing device by means of which a liquid sample can be discharged, wherein the cell concentration and/or the particle concentration is ascertained in one region of the dispensing device, and the cell concentration and/or particle concentration that has been ascertained is compared with a target value, and a force exerted on one cell and/or one particle is adjusted based on the result of the comparison.

### CROSS-REFERENCE TO RELATED APPLICATIONS

The present application is the U.S. national phase of International Application No. PCT/EP2019/084880 filed Dec. 12, 2019, which claims the benefit of and priority to Luxembourgian Patent Application No. 101086 filed Dec. 27, 2018, the entire disclosure of which is incorporated herein by reference.

### FIELD

The disclosure relates to a method for adjusting a cell concentration and/or a particle concentration in a dispensing device. In addition, the disclosure relates to a dispensing apparatus with a dispensing device.

### BACKGROUND

A plurality of apparatuses are known from the prior art, by means of which a liquid, in particular a liquid drop containing one cell, can be discharged. Devices are known in the art in which the discharge of the liquid is accomplished by means of free jet pressure methods. A distinction is made between such apparatuses in which the discharge of the liquid is accomplished by a drop-on-demand mode of operation or a continuous-jet mode of operation.

In the drop-on-demand mode of operation, individual liquid drops are deliberately generated from a liquid dispensing device of the apparatus at a selected time. Thus, individual liquid drops are generated on command using a separate activation signal. In contrast to the drop-on-demand mode of operation, in the continuous-jet mode of operation, a thin liquid jet is dispensed from the liquid dispensing device by pressure, and after discharge from the dispensing apparatus, the liquid jet breaks up into individual liquid drops that can be diverted electrostatically. In the continuous-jet mode of operation, a separate activation signal is thus not furnished for each individual liquid drop, and the individual liquid drops cannot be deliberately generated at a selected time.

In apparatuses that are known from the prior art, the problem often arises that the cell concentration in the liquid is too high, such that liquid drops are discharged that have more than one cell, which are unusable for further processing. The problem may also arise that the cell concentration in the liquid is too low. In this case, a plurality of liquid drops are discharged in succession that do not have any cells, such that the method of discharging the liquid drops is not efficient.

### SUMMARY

The object of the disclosure consists of providing an improved method.

The object is accomplished via a method for setting a cell concentration and/or a particle concentration in a dispensing device that has a fluid chamber via which a liquid sample can be discharged, wherein the cell concentration and/or the particle concentration is ascertained, and the cell concentration and/or particle concentration that has been ascertained is compared with a target value, and a force exerted on one cell and/or one particle is adjusted based on the result of the comparison.

A further object of the disclosure consists of providing an improved dispensing apparatus.

This object is accomplished by a dispensing apparatus that carries out a method according to the disclosure.

The object is also accomplished by a dispensing apparatus with a dispensing device, a sound generator, an actuating means for actuating the dispensing device, a control apparatus and an evaluation device for ascertaining a cell concentration and/or particle concentration in the dispensing device, wherein the control apparatus for adjusting a cell concentration and/or particle concentration in the dispensing device adjusts a force exerted on a cell and/or a particle as a function of a result of comparing the ascertained cell concentration and/or particle concentration with a target value.

The solution according to the disclosure has the advantage that the cell concentration and/or the particle concentration can be adjusted actively. This is a simple way to prevent a liquid sample that is not usable for further analysis from being discharged or analysed. As a result, an efficient method can be realised.

The dispensing apparatus is used to discharge at least one liquid sample. The liquid sample discharged via the dispensing apparatus can be a liquid drop, in particular a free-floating liquid drop. Alternatively, the discharged liquid sample can be a liquid jet which, after being discharged from a dispensing device of the dispensing apparatus, optionally breaks up into individual liquid drops. The dispensing apparatus can be a droplet generator. The liquid drop can have a volume in a range between 1 pl (picolitres) and 50 nl (nanolitres).

The liquid sample may be a liquid and may have at least one cell and/or at least one particle. The discharged liquid sample, in particular the liquid drop or liquid jet, may have no cells and/or no particles. Alternatively, the discharged liquid sample, in particular the liquid drop or liquid jet, may have a single cell and/or a single particle. The discharged liquid sample, in particular the liquid drops or liquid jet, can alternatively have more than a single cell and/or more than a single particle.

The liquid of the liquid sample can have a composition that is conducive to cell growth. The particle can be a glass or polymer bead and have substantially the same volume as the cell. The cell is a biological cell, in particular the cell is the smallest unit of life that is autonomously capable of reproduction and self-preservation.

The force can be part of a force field, in particular a multidimensional force field. By means of the force field, it is ensured that a force is respectively applied to each of the cells and/or particles of the liquid sample. The force can be adjusted in such a way that the cell and/or the particle is arranged in one direction and accelerated or decelerated or held substantially stationary, in particular stationary, in a discharge direction. If the cell slows down, it moves slower than it would move, for example, due to the flow force exerted on it due to weight force and/or a dispensing operation.

The force can be caused by sound. In this case, the liquid sample, in particular the cells and/or particles, is subjected to an acoustic field. In this case, a stationary acoustic field or a resonance can arise. Alternatively or additionally, the force can be caused by electromagnetism and/or electrostatics and/or hydrodynamics and/or optofluidics. Alternatively, the force can also be caused by a combination of the above-mentioned possibilities.

As a result of the acoustic field, the cells and/or particles can be arranged and/or moved and/or held in the dispensing device. This is possible because when an acoustic field, in particular a stationary acoustic field, is formed with respect to the cell and/or the particle, a force is exerted on the cell and/or the particle. This force is called acoustic radiation force or sound radiation force.

As subsequently explained in detail, the force or force field exerted on the cell and/or particle can prevent cells and/or particles from being discharged together with the liquid from the dispensing device, in particular a section of the dispensing device. After the liquid sample has been discharged, new liquid and optionally cells and/or particles flow into the section of the dispensing device. As a result the cell concentration and/or particle concentration in the section of the dispensing device can straightforwardly be adjusted.

The acoustic field can be generated by a sound generator. The sound generator is designed in such a way that it can generate an acoustic field with a certain frequency. The force can preferably be adjusted by adjusting an orientation and/or a frequency and/or an amplitude and/or a phase and/or a modulation of the sound. In addition, the sound generator can be designed in such a way that it can generate acoustic fields that have different frequencies and/or amplitudes and/or phases and/or modulations and/or orientations, and are in particular offset in time. The sound generator can be formed by a piezo converter.

The target value can be a value that is or can be predetermined. In such a case, the target value can be entered by the user or determined automatically. The target value can be stored in an electrical memory. The target value can have a value in the range between 100 cells per millilitre and 10⁸ cells per millilitre.

The result of the comparison may be that the cell concentration and/or particle concentration is less than, or equal to, or greater than the target value.

The method can be carried out automatically. This signifies that the method, without user involvement, automatically adjusts the cell concentration and/or particle concentration.

The cell and/or particle concentration can be determined by determining the number of cells and/or particles per volume, or the number of cells or a volume ratio between the cell volume and the sample volume. Alternatively or additionally, a value can be determined from which the concentration can be inferred. Such a value may arise, for example, from the analysis of the generated image. Parameters such as contrast, brightness, morphology, colour, pattern or the like may provide a basis for this.

In a particular embodiment, a triggering of the dispensing apparatus for discharging a portion of the liquid sample can be changed in order to adjust the cell and/or particle concentration. In particular, a specific time and/or the frequency of the triggering and/or the frequency of the triggering and/or the manner of the triggering and/or the amplitude of the triggering and/or a volume of the discharged liquid sample can be changed. These measures also make it easy to adjust the force and/or force field exerted on the cell and/or particle.

In a particular embodiment, the force can be adjusted such that the cell and/or particle is held substantially stationary, and in particular stationary, and the liquid sample is discharged by means of the dispensing device if the ascertained cell concentration and/or particle concentration is less than the target value. Likewise, the liquid sample can be discharged and the force field can be adjusted such that the cells and/or the particles are held substantially stationary, in particular stationary. In particular, the dispensing device can be subjected to the acoustic field and the liquid sample can be discharged via the dispensing device if the ascertained cell concentration and/or particle concentration is less than the target value.

In this case, at least one dispensing operation can be carried out in which the liquid sample is discharged that has liquid and no cells and/or particles. In particular, multiple dispensing operations can be carried out, in each of which respectively a liquid sample is discharged that contains the liquid and contains no or few cells and/or particles. In this way, a high volume of liquid is straightforwardly discharged very quickly.

As described above, discharging a liquid sample from the dispensing device effects a following flow of liquid sample within the dispensing device. In particular, as explained in greater detail below, the liquid sample present in the dispensing device, in particular in a fluid chamber of the dispensing device, follows into a discharge channel of the dispensing device. As a result, the cell concentration and/or particle concentration can be quickly and straightforwardly increased because it is likely that the liquid sample fed in has cells and/or particles. The cell concentration and/or particle concentration can be increased because cells and/or particles are moved, arranged, concentrated or kept in place in at least one node or nodal region of the acoustic field or of the minimum of the time-averaged pressure, and thus are not discharged during the dispensing operation.

In addition, it is possible that no force is exerted on the cell and/or particle, or force is adjusted in such a way that movement of the cell and/or particle in the discharge direction is possible if the ascertained cell concentration and/or particle concentration is equal to the target value. Likewise, it is possible that no force field is exerted on the cells and/or particles, or that a force field is adjusted such as to allow the cells and/or particles to move in the discharge direction.

In the context of the disclosure, “no force” means that no external force resulting from the above-described possibilities such as acoustophoresis is exerted on the cell and/or the particle. This external force acts in addition to the forces that are always acting on the cell and/or particle, such as for example weight.

In an embodiment in which no force is exerted on the cell and/or particle, the dispensing device is not subjected to an acoustic field. In this case, the liquid sample that has at least one, in particular exactly one, cell and/or at least one, in particular exactly one, particle can be discharged without the dispensing device being subjected to the acoustic field.

In the event that the cell concentration and/or particle concentration is greater than the target value, liquid sample can be discharged. As a result, a large quantity of liquid can straightforwardly be discharged in a short time, thus reducing the cell and/or particle concentration.

A large quantity of liquid can preferably be discharged by discharging the liquid sample for a predetermined period of time. Thus, the liquid sample can be discharged uninterruptedly during the predetermined time, or multiple dispensing operations can be carried out during the predetermined time.

Alternatively or additionally, a predetermined number of dispensing operations can be carried out. It is possible in this case for no force or force field to be exerted on the cells and/or particles. In particular, it is possible that the cells and/or particles are not subjected to an acoustic field.

In an alternative mode of operation, a force that has been adjusted in such a way as to keep the cell and/or the particle substantially stationary, in particular stationary, and no force, can be alternatingly exerted on the cell and/or the particle. Likewise, the cells and/or particles can be alternatingly subjected to a force field and to no force field. This can be accomplished by switching the acoustic field on or off for a predetermined time.

In particular, the sound generator can be switched off before the liquid sample is discharged, and the dispensing device can be subjected to the acoustic field again after the liquid sample has been discharged. To discharge the next liquid sample, the sound generator can once again be switched off.

Switching the sound generator on and off before discharging the liquid sample can be carried out multiple times in succession within a period of time that is or can be predetermined. As a result of the acoustic field being temporarily switched off, the cells and/or particles can be transported further during this period. Thus, it is possible that only a desired number or concentration of cells and/or particles are transported.

The above-described switching on and off of the sound generator can be carried out multiple times in succession for a number of dispensing operations that is or can be predetermined. During the respective dispensing operations, one liquid drop can be discharged.

Moreover, an advantage of this mode of operation consists in the fact that the number of discharged liquid samples that have more than one cell and/or particle can be reduced. In particular, this is advantageous because for the analysis of the discharged liquid samples, liquid samples that have a single sample and/or a single cell are particularly advantageous.

After the predetermined time period and/or after the number of dispensing operations, the dispensing device can once again be subjected to the acoustic field if the cell concentration and/or particle concentration is still greater than the target value.

As a result, in the above-described mode of operation, the result is straightforwardly accomplished that the discharged liquid sample has or can have, in addition to the liquid, at least one cell, and in particular exactly one cell, and/or at least one particle, and in particular exactly one particle.

Alternatively or additionally, a force can be exerted on the cell and/or the particle that is adjusted in such a way that it opposes a movement of the cell and/or the particle, but the cell and/or the particle is able to move. Likewise, it is possible that a force field can be exerted on the cells and/or particles that opposes a movement of the cells and/or particles.

In this case, a force is exerted on the cell and/or the particle, and this force slows down a movement of the cell and/or the particle compared to an operation in which the cell and/or the particle moves due to weight and/or due to the force exerted on the cell during a dispensing operation, such as for example a flow force. Preferably, the sound generator can be operated alternatingly between a state in which the force exerted on the cell and/or particle is adjusted such that the cell and/or particle is substantially stationary, in particular stationary, and a different state in which the force exerted on the cell and/or particle, as described above, slows the movement of the cell and/or particle.

In this mode of operation as well, the result is accomplished that the cells and/or particles can be transported further. Therefore, in this mode of operation as well, the discharged liquid sample may have, in addition to the liquid, at least one cell, in particular exactly one cell and/or at least one particle, in particular exactly one particle.

The alternating operation of the sound generator can be carried out for a predetermined period of time and/or for a predetermined number of dispensing operations. During the respective dispensing operations, one liquid drop can be discharged.

After the predetermined time period and/or after the number of dispensing operations, the dispensing device can once again be subjected to the acoustic field if the cell concentration and/or particle concentration is still greater than the target value.

In a particular mode of operation, a two- or three-dimensional force field, in particular an acoustic field, can be generated. This force field, in particular acoustic field, can arrange the at least one cell and/or the at least one particle in a desired arrangement (area, points, lines, pattern or Chladni sound figure); in particular, such a force field, in particular acoustic field, can focus or concentrate or align the cells and/or particles in the centre of the discharge channel.

If the cell and/or particle concentration is then equal to the target value, the force field, in particular the acoustic field, can in addition also be selected, and in particular can be adjusted, in such a way that the cells are transported further in the deploying direction.

If the cell and/or particle concentration does not match the target value, the force field, in particular the acoustic field, can be selected, and in particular can be adjusted, in particular in addition to the central focusing, so that the cells are transported further only slowly, and in particular not at all, in the deploying direction.

If the cell and/or particle concentration is less than the target value, the force field, in particular the acoustic field, can be selected, and in particular can be adjusted, in particular in addition to the central focusing, so that the cells are transported further only slowly, and in particular not at all, in the deploying direction; and by repeatedly dispensing drops, additional cells and/or particles flow into the discharge channel and thus the concentration is increased.

If the cell and/or particle concentration is greater than the target value, the force field, in particular the acoustic field, can be selected, and in particular can be adjusted, in particular in addition to the central focusing, so that the cells are transported further only slowly, and in particular not at all, in the deploying direction; and as a result of drops of a certain volume range being dispensed within a certain dosing frequency range, a suitable quantity of cells and/or particles are transported further.

A method and/or a dispensing apparatus is particularly advantageous, in this case, by which it is possible to carry out one or the other of the above-mentioned modes of operation that depend on the result of the comparison. The control apparatus in this case can control the sound generator in such a way that the dispensing apparatus is or is not subjected to the acoustic field. Moreover, the control apparatus can control the sound generator in such a way that the type of acoustic field can be selected, and in particular can be adjusted. Alternatively, the control apparatus can modify the dispensing operation. Moreover, the control apparatus can control the actuating means in such a way that the liquid sample is discharged from the dispensing device.

In a particular embodiment, the dispensing device may have a discharge channel through which the liquid sample may be discharged. At least a portion of the discharge channel can be observed in order to obtain the cell concentration and/or particle concentration. In particular, in order to ascertain the cell concentration and/or particle concentration, the entire discharge channel or a portion of the discharge channel containing a discharge opening can be observed.

Ascertaining the cell concentration and/or particle concentration in the at least one portion of the discharge channel affords the advantage that it is possible to predict whether the liquid sample, in particular the liquid drop, to be discharged in the next step, or the liquid samples, in particular the liquid drops, to be discharged in the next steps, contain a certain number of cells and/or particles. In particular, it is possible to predict whether the liquid drops to be discharged will contain no cells or a single cell or multiple cells and/or no particles or a single particle or multiple particles. This knowledge makes it possible for dispensing operations to be carried out very efficiently.

In this case, the liquid sample contained in the at least one portion of the discharge channel can be discharged immediately during a next dispensing operation. Alternatively, the liquid sample contained in the at least one portion of the discharge channel can be discharged only after a predetermined number of dispensing operations.

The discharge of the liquid sample can be carried out by a drop-on-demand mode of operation. In this case, the dispensing apparatus, as already described above, discharges the liquid sample discretely and not continuously. To implement the drop-on-demand mode of operation, the dispensing apparatus can have an actuating means, for example, which can be a piezoelectrically operated actuator. Moreover, the dispensing device can have a section, in particular a mechanical membrane, that can be actuated by the actuating means. When the actuating means is actuated, a volume of the discharge channel is reduced and the liquid sample, in particular a liquid drop, is ejected from the dispensing device. As a result, in the drop-on-demand mode of operation, the cells and/or particles that are present in the discharge channel can be moved stepwise along a deploying direction of the liquid sample.

In order to ascertain the cell concentration and/or the particle concentration, the number of cells and/or particles can be ascertained in at least a portion of the discharge channel, in particular in the entire discharge channel, preferably in a nozzle-shaped end region of the discharge channel. As a result, the cell concentration and/or particle concentration in at least one portion of the discharge channel or the entire discharge channel can straightforwardly be obtained.

Alternatively, the particle and/or cell concentration or the particle and/or cell count can be determined after ejecting a portion of the liquid sample. It is possible for example to determine the number of drops and the particles and/or cells they contain. In particular, this can occur with the help of at least one image. This image can for example be taken of the liquid sample in flight or after the liquid sample has landed on a surface. An image can also be created of a portion of a container into which the at least one drop has been placed.

To determine the number of cells and/or particles, alternatively or additionally, an image of the at least one portion of the discharge channel can be generated. In particular, an image of the entire discharge channel can be generated. In this case, the dispensing apparatus can have an optical detection device that has an imaging device. The imaging device serves to generate at least one image of the at least one portion of the discharge channel or of the entire discharge channel. Based on the generated image, the evaluation device can ascertain the number of cells and/or particles present in the at least one portion of the discharge channel, in particular in the entire discharge channel.

Alternatively or additionally, the cell concentration and/or the particle concentration can be determined by determining how many liquid droplets are dispensed, each respectively having no cells and/or no particles or having a single cell and/or a single particle or having multiple cells and/or multiple particles.

The control apparatus can regulate the cell concentration and/or particle concentration to the target value or to a value in a target range.

In one particular embodiment, to adjust the cell concentration and/or the particle concentration in the dispensing device, in particular in the discharge channel, the at least one portion of the discharge channel, in particular the entire discharge channel, can be subjected to an acoustic field, in particular a two- or three-dimensional stationary acoustic field. This acoustic field can be configured in such a way that at least one cell and/or at least one particle is held substantially stationary, in particular stationary, in at least one direction. The cell and/or the particle are present in the discharge channel, or portion of the discharge channel, subjected to the acoustic field. In particular, the acoustic field may be configured in such a way that the cell and/or particle is held or slowed in a direction opposite to a deploying direction of the liquid. Following a dispensing operation, cells arranged in another portion of the discharge channel can reach the portion of the dispense channel.

As a result, the cells and/or particles are straightforwardly prevented from sedimenting, or sedimentation is slowed, within the dispensing device, in particular within the discharge channel. Moreover, the acoustic field is configured in such a way as to prevent the cell and/or particle from being discharged together with the liquid when the liquid sample is discharged via the dispensing device. As a result, an acoustophoretic focusing or concentration of the cells and/or particles is achieved by the sound generator and the emitted acoustic field in the at least one portion of the discharge channel, in particular in the entire discharge channel.

Since, after a dispensing operation, liquid and possibly cells and/or particles flow out of a fluid chamber of the dispensing device into the discharge channel, the cell concentration and/or particle concentration in the at least one portion of the discharge channel can be straightforwardly increased. The fluid chamber can be used to accommodate the liquid sample. In particular, the user of the dispensing device can put the liquid sample into the fluid chamber. The fluid chamber in this case is fluidically connected with the discharge channel. There is a fluidic connection between two components if the liquid can flow from one component into the other component.

The frequency, orientation, amplitude and/or phase of the acoustic field emitted by the sound generator may be selected such that a wall separation of the dispensing device along the deploying direction of the liquid is equal to half the wavelength of the sound wave in the liquid or an integer multiple of half the wavelength. In the case of two- or three-dimensional fields, in particular more complex geometries and/or more complex excitations (for example multiple frequencies), non-trivial superpositions may arise. Stationary waves or acoustic fields can also be generated in this way. Consequently, the result is achieved that stationary waves are respectively generated by superimposing a propagating sound wave and a sound wave reflected on the walls of the dispensing device. The stationary waves also extend parallel to the deploying direction of the liquid. This has the effect that the cells and/or particles are aligned by the acoustic field in a direction transverse, in particular perpendicular, to the deploying direction of the liquid sample.

The fluid chamber and/or the at least one portion of the discharge channel can be subjected to multiple acoustic fields, in particular acoustic fields that are time-offset with respect to each other. The acoustic fields can differ in their frequency, amplitude, phase, modulation and/or orientation. In particular, the fluid chamber can be subjected to acoustic fields of different frequencies, in particular multiple acoustic fields that are time-offset with respect to each other, if the cell concentration and/or the particle concentration is less than or greater than or equal to or similar to the target value.

By applying one or more acoustic fields of different frequency, amplitude, phase, modulation and/or orientation to the discharge channel, the result is achieved that the cells and/or particles present within the at least one portion of the discharge channel are moved to new positions. The repositioning of the cells and/or particles within the at least one portion of the discharge channel reduces the risk that a liquid will be discharged that contains more than one cell and/or more than one particle.

By applying one or more acoustic fields to the fluid chamber that have different frequency, amplitude, phase, modulation and/or orientation, the result is accomplished that the liquid present in the fluid chamber is mixed. As a result, a substantially homogeneous distribution, or if needed a more inhomogeneous distribution, is realised, of the cells and/or particles within the liquid present in the fluid chamber. This is advantageous because as a result, the probability is increased that after a liquid discharge, a liquid sample having at least one cell and/or at least one particle will flow from the fluid chamber into the discharge channel.

Another advantage of subjecting the fluid chamber and/or the discharge channel to acoustic fields of different frequency, amplitude, phase, modulation and/or orientation consists of the fact that clusters, namely multiple interconnected cells and/or particles, can be broken up.

In a particular embodiment, the discharge channel may have at least one section that has a flow cross-section that is variable along a deploying direction of the liquid. For example, the discharge channel may have a nozzle at its end that is further from the fluid chamber. The variable flow cross-section ensures that the flow paths of the individual cells and/or particles differ from each other. Thus, a cell flowing along a central axis of the discharge channel may have a shorter flow path than, for example, a cell that flows near an discharge channel wall and is deflected by the discharge channel wall. This is a simple way to prevent a liquid sample, in particular the liquid drop, from being discharged with more than one cell and/or particle.

The dispensing apparatus can have a deflection and/or suction device. The diversion device is used to deflect the discharged liquid sample, in particular the discharged liquid drop. The suction device is used to suction off the dispensed liquid sample, in particular the discharged liquid drop. The diversion operation and/or the suctioning operation may depend on the cell concentration and/or particle concentration obtained. The discharged liquid sample can then be diverted and/or suctioned out into a reject container. Alternatively, the discharged liquid sample can be fed into a container, in particular a container of the microtitre plate.

The diversion and/or suctioning can take place before the discharged liquid sample enters the container, in particular the container of the microtitre plate. The discharged liquid sample can then be diverted and/or suctioned out if the liquid sample contains no cells and/or no particles. Alternatively, the discharged liquid sample can be diverted and/or suctioned out if the number of cells and/or particles contained in the liquid sample is greater than a predetermined value, in particular greater than 1.

The dispensing apparatus can have a displacement device. The dispensing device and/or the container and/or the reject container can be displaced by means of the displacement device. The displacement operation can depend on the ascertained cell concentration and/or particle concentration and/or on a dosing operation. Thus, the liquid sample can be fed into the reject container if no cells, and/or no predetermined number of cells and/or particles, are present in the discharged liquid sample. By contrast, the discharged liquid sample can be fed into the container if a single cell and/or a single particle is arranged in the liquid sample. As described above, depending on the ascertained cell concentration and/or cell concentration in the at least one portion of the discharge channel, in particular the entire discharge channel, it can be predicted whether the discharged liquid sample has no cells, a single cell or multiple cells and/or has no particles, a single particle or multiple particles.

The dispensing device, in turn, can be detachably connected to the remaining parts of the dispensing apparatus, in particular mechanically. As a result, the dispensing device can straightforwardly be switched out.

A computer program is particularly advantageous that comprises commands that, when the program is executed by a computer, cause the computer to carry out the method according to the disclosure. A data carrier on which the computer program according to the disclosure is stored is also advantageous. In addition, a data carrier signal that transmits a computer program according to the disclosure is advantageous.

### BRIEF DESCRIPTION OF THE DRAWING VIEWS

The subject matter of the disclosure is shown schematically in the figures, wherein elements that are the same or have the same effect are mostly provided with the same reference symbols. In the figures:

FIG. 1 shows a dispensing apparatus according to the disclosure,

FIG. 2 shows a dispensing device of the dispensing apparatus in a state in which the dispensing device is not subjected to an acoustic field,

FIG. 3 shows the dispensing device in a state in which the dispensing device is subjected to an acoustic field,

FIG. 4 shows the dispensing device in a state in which the dispensing device is subjected to an acoustic field and a liquid sample is discharged from the dispensing device,

FIG. 5 shows the dispensing device in a state in which the cell concentration in a portion of the discharge channel is too high,

FIG. 6 shows the dispensing device in a state in which liquid samples are discharged from the dispensing device,

FIG. 7 shows the dispensing device in a state in which the cells are concentrated centrally in the discharge channel and the cell concentration is too low,

FIG. 8 shows the dispensing device from FIG. 7 in a state in which multiple liquid drops are discharged,

FIG. 9 shows the dispensing device in a state in which the cells are concentrated centrally in the discharge channel and liquid samples are discharged,

FIG. 10 shows the dispensing device in a state in which the cells are aligned centrally in the discharge channel and liquid samples are discharged.

### DETAILED DESCRIPTION

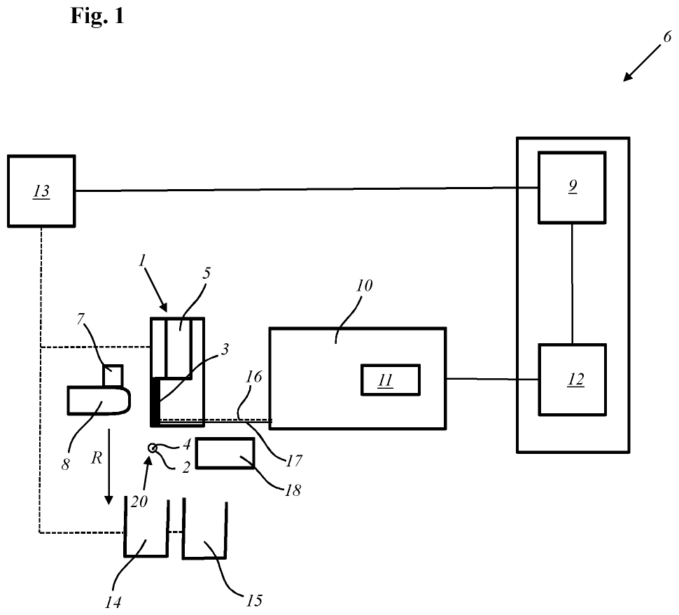

FIG. 1 shows a dispensing apparatus 6 according to the disclosure, which has a dispensing device 1 for discharging a liquid sample 20 that may have liquid 2 and at least one cell 4 and/or at least one particle. In addition, the dispensing apparatus 6 has an optical detection device 10 for optically detecting at least a portion of a discharge channel 3 of the dispensing device 1. The dispensing device 1 may have a fluid chamber 5 that contains liquid 2 and cells 4 and/or particles. The liquid chamber 5 is fluidically connected to the discharge channel 3.

The optical detection device 10 has an imaging device 11 for generating an image of the at least one portion of the discharge channel 3 and additional elements that are not shown in the drawings. To generate an image, the at least one part of the discharge channel 3 is illuminated by means of an illumination light 17 and a detection light 16 emanating from the at least one part of the discharge channel 3 is detected by the optical detection device 10. The imaging device 11 generates an image of the at least one portion of the discharge channel 3 based on the detected detection light 16.

The optical detection device 10 is electrically connected to an evaluation device 12. The evaluation device 12 can determine the number of cells 4 and/or particles contained in the at least one part of the discharge channel 3 based on the generated image. Thus, the evaluation device 12 can determine the cell concentration and/or particle concentration in the at least one portion of the discharge channel 3.

The evaluation device 12 is electrically connected to a control device 9. The control apparatus 9 and evaluation device 12 can be part of a computer. Based on the evaluation result of the evaluation device 12, the control apparatus 9 controls the dispensing operation of the dispensing device 1. The control apparatus 9 is electrically connected to a displacement device 13. The displacement device 13 can move the dispensing device 1 and/or the container 14 and/or a reject container 15 in such a way that the liquid 2 can be dispensed into the desired storage location.

In addition, the control apparatus 9 can control a deflection and/or suction device 18 of the dispensing apparatus 6. In this case, the control apparatus 9 can control the diversion device and/or suction device 18 in such a way that the discharged liquid sample 20 is diverted and/or suctioned away if the liquid sample 20 has no cells 4 and/or no particles, or if the liquid sample 20 has multiple cells 3 and/or multiple particles. Based on the cell concentration and/or particle concentration determined by the evaluation device 12, the control apparatus 9 can predict whether the liquid drop or liquid drops to be discharged during the next dispensing operation will have no cells and/or particles, or will have one or more cells and/or particles. The control apparatus 9 can then control the displacement device 13 and/or the diversion device and/or suction device 18 as a function of the prediction.

FIG. 1 shows a state in which the dispensing device 1 has discharged a liquid sample 20, in particular a liquid drop, that has a single cell 4. The liquid 2 together with the cell 4 is fed into the container 14, which is for example part of a microtitre plate that is not shown in greater detail.

The dispensing apparatus 6 has an actuating means 8 that is pressed against a section of the dispensing device 1 to actuate the dispensing device 1. In this case, the liquid sample 20, in particular a liquid drop, is discharged if the actuating means 8 presses against the section of the dispensing device 1. The actuating means 8 and the optical detection device 10 are opposite each other with respect to the dispensing device 1. The dispensing device 1 consists at least partially of a transparent material, such that at least a portion of the discharge channel 3 can be detected by means of the optical detection device 10.

The dispensing apparatus 1 also has a sound generator 7 that emits an acoustic field. In this case, the sound generator 7 is positioned in such a way that at least a portion of the discharge channel 3, in particular the entire discharge channel 3, can be subjected to the acoustic field. In particular, the sound generator 7 can be in mechanical contact with the actuating means 8 and thus can transmit the sound particularly efficiently.

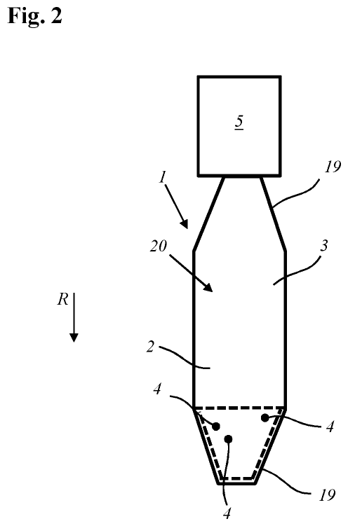

FIG. 2 shows the dispensing device 1 of the dispensing apparatus 6 in a state in which the dispensing device 1 is not subjected to an acoustic field. In particular, FIG. 2 shows an enlarged view of the dispensing device 1 from the front.

The discharge channel 3 is completely filled with the liquid sample 20. In this case, only that portion of the discharge channel 3 that has a discharge opening of the discharge channel 3, shown in dashed lines in FIG. 2, is observed via the optical detection device 10. Three cells 4 of the liquid sample 20 are arranged in the observed portion of the discharge channel 3. During a dispensing process, the liquid sample 20 is discharged along a deploying direction R. The discharge channel 3 has a nozzle-shaped end at the end thereof remote from that of the fluid chamber 5. In addition, the discharge channel 3 has a nozzle-shaped end at its end facing towards the fluid chamber 5.

The cells 4 arranged in the discharge channel 3 move towards the discharge opening of the discharge channel 3 due to weight, even if no liquid 2 is discharged from the dispensing device 1.

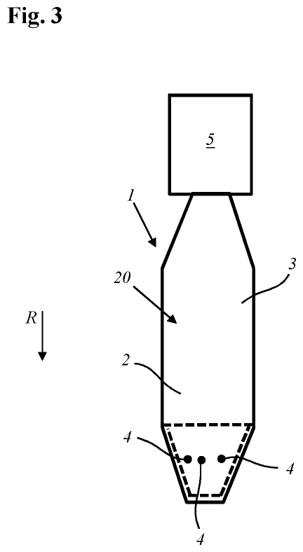

FIG. 3 shows the dispensing device 1 in a state in which the dispensing device 1 is subjected to an acoustic field. In particular, the dashed portion of the discharge channel 3 is subjected to the acoustic field. By subjecting the portion of the discharge channel 3 to the acoustic field, the result is achieved that a force opposite the deploying direction R acts on the cells 4. Thus, the cells 4 do not move, or move to a lesser extent, towards the nozzle-shaped end due to the weight force. In this case, the cells 4 can be slowed or held substantially stationary, in particular stationary, in the deploying direction due to the force exerted on them. The cells 4 are aligned by the acoustic field in a direction transverse, in particular perpendicular, to the deploying direction R.

Since the upper end of the dispensing device 1 and the lower end of the dispensing device 1 have substantially the same design, by superimposing respectively one or more sound waves emitted from the sound generator 7 and one or more sound waves reflected on one or more discharge channel walls 19, one or, in the multidimensional case, multiple stationary waves can be generated, and the result can thus be achieved that the cells 4 are held substantially stationary, in particular stationary. The stationary waves run parallel to the deploying direction R and run between the upper end of the dispensing device 1 that faces towards the fluid chamber 5 and the lower end of the dispensing device 1 that faces away from the fluid chamber 5.

In the following, a first mode of operation of the dispensing apparatus 6 according to the disclosure is described with reference to FIGS. 1 to 4.

The imaging device 11 generates an image of the discharge channel 3, in particular the portion of the discharge channel 3 shown in dashed lines in FIG. 2. Based on the generated image, the evaluation device 12 determines the number of cells 4 contained in the dashed portion of the discharge channel 3 and thus determines the cell concentration in the observed portion of the discharge channel 3.

The control apparatus 9 checks whether the cell concentration is less than a predetermined target value. In the case shown in FIGS. 1-4, it is assumed that the cell concentration in the observed portion of the discharge channel 3 is too low, namely less than the target value.

In the next step, the sound generator 7 is activated and the discharge channel 3, in particular the portion of the discharge channel 3 shown in dashed lines, is subjected to an acoustic field generated by the sound generator 7. As described above, the acoustic field is configured in such a way that a force is exerted on the cells 4 to prevent the cells 4 from moving towards the nozzle-shaped end of the discharge channel 3 that faces away from the fluid chamber 5.

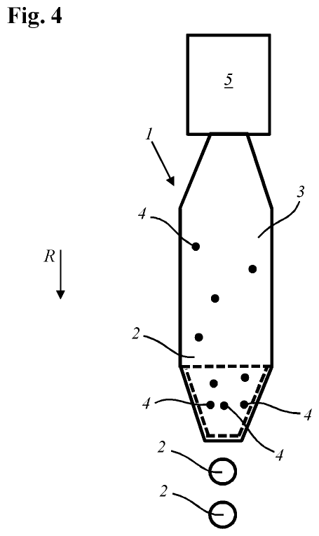

In addition, one dispensing operation is carried out, or multiple dispensing operations are carried out. In particular, multiple liquid drops are discharged, as shown in FIG. 4. In addition, liquid drops are discharged that exclusively contain liquid 2 and thus do not contain any cells and/or particles. Since a force directed in the direction opposite the deploying direction R acts on the cells 4 that are arranged in the portion of the discharge channel 3, the cells 4 remain in their position during the dispensing operation or operations. The liquid discharge causes a portion of the fluid present in the fluid chamber 5 to flow into the discharge channel 3 via the upper end of the dispensing device 1. Since the liquid 2 present in the fluid chamber 5 contains cells 4, new cells 4 thus enter the observed portion of the discharge channel 3. Specifically, in the embodiment shown in FIG. 4, two new cells 4 enter the observed portion of the discharge channel 3, such that the cell concentration in the observed portion of the discharge channel 4 has been increased. Moreover, four additional cells 4 from the fluid chamber 5 reach the non-observed portion of the discharge channel 3. Subsequently, as described above, the cell concentration is again determined and if necessary the above-described steps are repeated until the cell concentration has reached the target value.

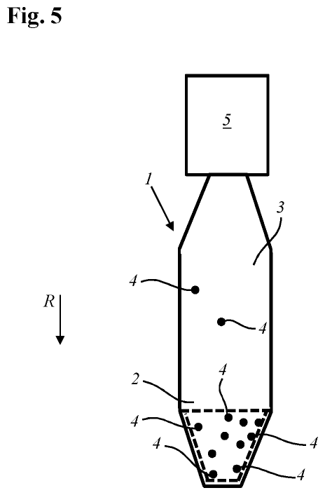

Below, a second mode of operation of the dispensing apparatus 6 according to the disclosure is described with reference to FIGS. 1, 5 and 6. As in the first mode of operation, the cell concentration is first ascertained in the portion of the discharge channel 3 shown in dashed lines in FIG. 5. The control apparatus 9 then ascertains that the cell concentration is greater than the target value.

In the next step, the sound generator 7 is switched off and the actuating means 8 is actuated such that a dispensing operation is carried out. After the liquid sample 20 has been discharged, the sound generator 7 is switched back on, and the observed portion of the discharge channel 3 is subjected to the acoustic field. Switching the sound generator on and off before the liquid sample 20 is discharged is repeated multiple times in a predetermined period of time and/or for a predetermined number of dispensing operations.

Alternatively, the sound generator 7 in the switched-on state is set in such a way that the force exerted on the cells causes the cells to be held substantially stationary, in particular stationary. Subsequently, the sound generator 7 is not switched off, but is shifted to a second state in which the force acting on the cells is less than the flow force acting on the cells during the dispensing operation. In addition, a dispensing operation is carried out if the sound generator 7 is in the second state. The force acting on the cells in the second state of the sound generator may be greater than the weight force acting on the cells, but less than the flow force that acts on the cells during the dispensing operation. Consequently, the movement of the cells towards the discharge opening is slowed.

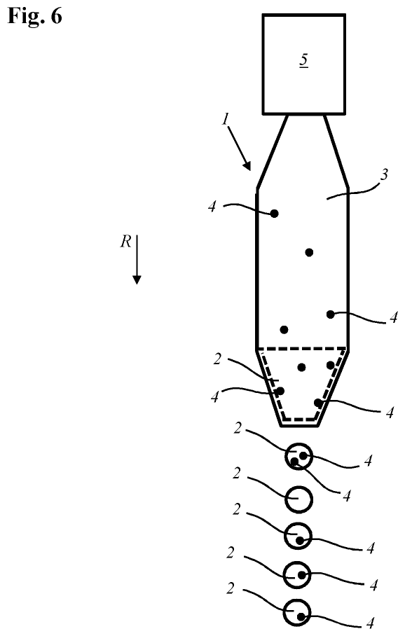

Regardless of which of the above-mentioned methods is used to operate the sound generator 7, a plurality of discharged liquid samples 20 have only a single cell 4, as is apparent in FIG. 6. After the predetermined time period and/or the predetermined number of dispensing operations, the cell concentration and/or particle concentration is checked again. The sound generator is switched on again if the cell concentration is greater than the target value. The above-mentioned steps are repeated multiple times until the cell concentration is equal to the target value or less than the target value.

Since, in the state shown in FIG. 6, some cells 4 have been discharged compared to the state shown in FIG. 5 and thus are no longer arranged in the observed portion of the discharge channel 3, the cell concentration in the observed portion of the discharge channel 3 is lower than prior to the dispensing operations.

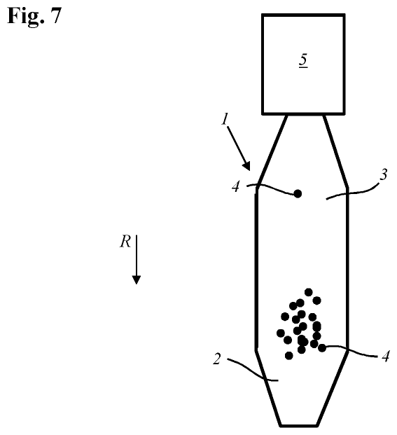

FIGS. 7 to 10 show a third mode of operation of the dispensing apparatus according to the disclosure. The modes of operation described in FIGS. 7 to 10 share the fact that the cells 4 that are present in the discharge channel 3 are concentrated or aligned in the discharge channel 3 using an acoustic field. In addition, and in particular subsequently, the cell and/or particle concentration is adjusted. The cell and/or particle concentration can be adjusted by the corresponding region of the discharge channel 3 being subjected to a different acoustic field. Alternatively, the cell concentration and particle concentration can be adjusted by changing the setting of the acoustic field that causes the cells to be concentrated or aligned, such as for example the frequency, amplitude, etc., of the acoustic field. In this case, it is not necessary that multiple acoustic fields are applied to the discharge channel, but instead, with the same acoustic field, concentration or alignment can be effected and the cell concentration and particle concentration can be adjusted.

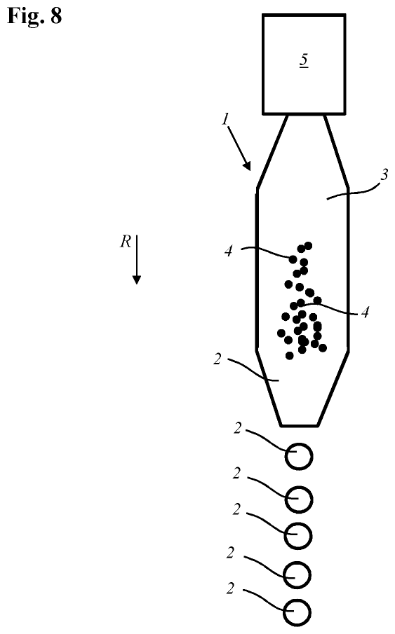

FIGS. 7 and 8 show a state in which the cells are concentrated in a central portion of the discharge channel 3. The cells are concentrated in the central region of the discharge channel 3 as a result of the discharge channel 3 being subjected to an acoustic field. The acoustic field is adjusted in such a way that the cells are respectively subjected to a force that causes them to be concentrated in the central region of the discharge channel 3 shown in FIG. 7.

In this case, the cell concentration in the observed region of the discharge channel 3, which is not shown in FIGS. 7 and 8, is less than the target value. Therefore, the acoustic field is adjusted in such a way that the cells 4 arranged in the observed region of the discharge channel 3 are not moved in the deploying direction R. In particular, the acoustic field is adjusted in such a way that the cells 4 arranged in the discharge channel 3 do not move even after multiple of the liquid drops shown in FIG. 8 have been discharged, and are thus substantially stationary.

In contrast, as is apparent from FIG. 8, as a result of the dispensing operations, some of the cells 4 arranged outside the observed region of the discharge channel 3 in FIG. 7, which for example were arranged in the fluid chamber 5 before the dispensing operation, enter the observed region, such that the cell concentration in the observed region of the discharge channel 3 increases.

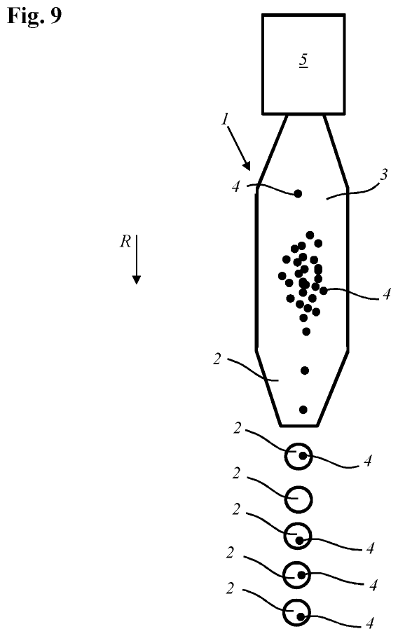

In the embodiment shown in FIG. 9, the cells 4 are concentrated in the centre of the discharge channel 3 owing to the applied acoustic field. Although not shown in FIG. 9, in the embodiment the cell concentration in the observed portion, not shown, of the discharge channel 3 was too high, namely above the target value. Thus, analogously to the mode of operation described with reference to the second mode of operation, the sound generator is alternatingly switched on and off or adjusted (for example by reducing the force on the cells) so that only some of the cells are supplied to the observed region, such that the cell concentration in the observed region is reduced and the probability is increased that the discharged liquid samples 20 each respectively have a single cell 4.

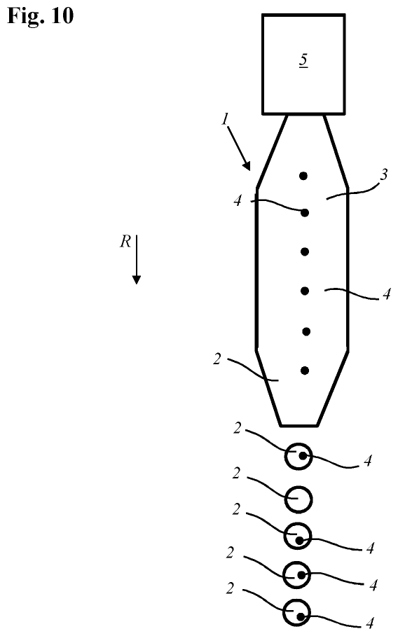

In the embodiment shown in FIG. 10, the cells 4 are aligned centrally owing to the adjacent acoustic field. The cell concentration in the observed portion, not shown, of the discharge channel 3 is then equal to the target value. In this case, the acoustic field does not need to be further modified to yield a change in cell concentration in the observed portion of the discharge channel 3.

In each of the above-described modes of operation, an image is generated of the discharge channel 3, in particular of the portion of the discharge channel 3, and the number of cells 4 and/or particles arranged in the discharge channel 3 is determined. Depending on the number of cells 4 present in the discharge channel 3, the observed portion of the discharge channel 3 is or is not subjected to the acoustic field.

### LIST OF REFERENCE SIGNS

1 Dispensing device

2 Liquid

3 Discharge channel

4 Cell

5 Fluid chamber

6 Dispensing apparatus

7 Sound generator

8 Actuating means

9 Control apparatus

10 Detection device

11 Imaging device

12 Evaluation apparatus

13 Displacement device

14 Container

15 Reject container

16 Detection light

17 Illumination light

18 Deflection and/or suction device

19 Discharge channel wall

20 Liquid sample

R Deploying direction

1. A method for setting a cell concentration and/or a particle concentration in a dispensing device (1) by means of which a liquid sample (20) can be discharged, the method comprising:
ascertaining the cell concentration and/or the particle concentration in the liquid sample;
comparing the cell concentration and/or particle concentration that has been ascertained with a target value; and
adjusting a force exerted on one cell and/or one particle based on a result of the comparison.

2. The method according to claim 1, wherein
the force is caused by sound and the force is adjusted by adjusting an orientation and/or a frequency and/or an amplitude and/or a phase and/or a modulation of the sound.

3. (canceled)

4. (canceled)

5. The method according to claim 1, wherein a triggering of the dispensing apparatus (6) is changed in order to adjust the cell concentration and/or particle concentration, wherein the triggering is changed by changing a specific time of the triggering and/or a frequency of the triggering and/or a manner of the triggering and/or an amplitude of the triggering and/or a volume of the discharged liquid sample (20) of the triggering.

6. (canceled)

7. The method according to claim 1, wherein the force is adjusted such that the cell and/or particle is held substantially stationary, and the liquid sample (20) is discharged by of the dispensing device (1) if the ascertained cell concentration and/or particle concentration is less than the target value, wherein the liquid sample (20) discharged by the dispensing device has liquid (2) and no cells and/or particles.

8. (canceled)

8. (canceled)

9. The method according to claim 1, wherein the force is adjusted such that movement of the cell and/or particle in a deploying direction (R) is possible if the ascertained cell concentration and/or particle concentration is equal to the target value.

10. The method according to claim 1, wherein if the cell concentration and/or particle concentration is greater than the target value, the liquid sample (20) is discharged.

11. (canceled)

12. The method according to claim 10, wherein
a. the force is alternatingly adjusted to keep the cell and/or the particle substantially stationary, and then to exert no force on the cell and/or one particle, or
b. the force is adjusted to oppose a movement of the cell and/or the particle, but the cell and/or the particle can move in a deploying direction (R).

13. (canceled)

14. The method according to claim 10, wherein at least one dispensing operation is carried out in which the discharged liquid sample (20) has liquid (2) and at least one cell (4) and/or at least one particle.

15. The method according to claim 1, wherein the dispensing device (1) has a discharge channel (3) through which the liquid sample (20) is discharged from the dispensing device, and the cell concentration and/or particle concentration is ascertained from a determination of the number of cells (4) and/or particles in at least a portion of the discharge channel (3) based on an image of the at least a portion of the discharge channel.

16. (canceled)

17. (canceled)

18. (canceled)

19. The method according to claim 15, wherein the force exerted on the cell and/or particle is provided by subjecting the at least a portion of the discharge channel (3) to an acoustic field.

20. The method according to claim 19, wherein the dispensing device (1) has a fluid chamber (5) for accommodating the liquid sample (20), the fluid chamber (5) being fluidically connected to the discharge channel (3), and wherein
a. the fluid chamber (5) and/or the at least one portion of the discharge channel (3) is subjected to acoustic fields that differ from one another in frequency and/or amplitude and/or phase and/or modulation and/or orientation and/or wherein
b. the fluid chamber (5) and/or at least a portion of the discharge channel (3) is subjected to acoustic fields of different frequency and/or amplitude and/or phase and/or modulation and/or orientation if the cell concentration and/or the particle concentration is less than the target value.

21. (canceled)

22. (canceled)

23. (canceled)

24. (canceled)

25. (canceled)

26. A dispensing apparatus (6) comprising:
a dispensing device (1) including a fluid chamber (5) into which a liquid sample (20) is introduced and a discharge channel (3) fluidically connected to the fluid chamber (5) through which the liquid sample (20) is discharged from the dispensing device (1), wherein the liquid sample (21) includes a liquid (2) and cells (4) and/or particles;
a sound generator (7) arranged in association with the dispensing device (1), the sound generator being operable to generate an acoustic field;
an actuating means (8) for actuating the dispensing device (1) to cause the dispensing device (1) to discharge a volume of the liquid sample (20) from the dispensing device (1);
an evaluation device (12) configured to ascertain a cell concentration and/or particle concentration in the dispensing device (1); and
a control apparatus (9) connected to the dispensing device (1), the sound generator (7), the actuating means (8), and the evaluation device (12);
wherein the control apparatus (9) is configured to compare the ascertained cell concentration and/or particle concentration with a target value to provide a comparison result, and configured to adjust the cell concentration and/or particle concentration in the dispensing device (1) by adjusting a force exerted on a cell (4) and/or a particle in the liquid sample (20) as a function of the comparison result.

27. (canceled)

28. The dispensing apparatus (6) according to claim 26, wherein the control apparatus (9) is configured to adjust the force such that the cell and/or particle is held substantially stationary, and to control the actuating means (8) such that the liquid sample (20) is discharged via the dispensing device (1) if the ascertained cell concentration and/or particle concentration is less than the target value.

29. The dispensing apparatus (6) according to claim 28, wherein the control apparatus (9) is configured to control the actuating means (8) such that a dispensing operation for discharging a volume of the liquid sample (20) having a liquid (2) and no cells and/or particles is carried out multiple times in succession.

30. The dispensing apparatus (6) according to claim 26, wherein the control apparatus (9) is configured to cause no force to be exerted on the cell and/or particle, or to adjust the force such that movement of the cell and/or particle in a discharge direction is possible if the ascertained cell concentration and/or particle concentration is equal to the target value.

31. (canceled)

32. (canceled)

33. (canceled)

34. (canceled)

35. The dispensing apparatus (6) according to claim 26, further comprising an imaging device (11) arranged to generate an image of at least a portion of the discharge channel (3) of the dispensing device (1), wherein the evaluation device (12) is configured to ascertain the number of cells (4) and/or particles present in the at least one portion of the discharge channel (3) based on the generated image.

36. (canceled)

37. The dispensing apparatus (6) according to claim 26, wherein the discharge channel (3) has at least one section having a flow cross-section that varies along a deploying direction (R) of the liquid sample (20).

38. The dispensing apparatus (6) according to claim 26, further comprising a diversion device (18) for deflecting the discharged liquid sample (20), wherein the control apparatus (9) is configured to control the diversion device (18) depending on the ascertained cell concentration and/or particle concentration.

39. The dispensing apparatus (6) according to claim 26, further comprising a displacement device (13), by means of which the dispensing device (1) and/or a container (14) for receiving the liquid sample (20) and/or a reject container (15) for receiving the liquid sample (20) can be displaced, wherein the control apparatus (9) is configured to control the displacement device (13) depending on the ascertained cell concentration and/or particle concentration.

40. A non-transient computer readable storage medium comprising a computer program comprising instructions that, when the computer program is executed by a computer (12), cause the computer to carry out the method according to claim 1.

41. (canceled)

42. (canceled)
